(19) United States
(12) Patent Application Publication
(10) Pub. No.: US 2009/0040091 A1
(43) Pub. Date: Feb. 12, 2009

(54) SYSTEMS AND METHODS FOR PROGRAMMING A REMOTE CONTROL

(76) Inventors: Lance Carlson, Longmont, CO (US); Curt Bruner, Longmont, CO (US)

Correspondence Address: Brett Bornsen;Duft Bornsen & Fishman, LLP, Suite 302, 1526 Spruce Street, Boulder, CO, 80302, US

(21) Appl. No.: 11/836,029

(22) Filed: Aug. 8, 2007

(51) Int. Cl. G08C 19/12

(52) U.S. Cl. 341/176

(57) ABSTRACT

Systems and methods are provided for programming a remote control to remotely operate a media device. The remote control is configured to communicate with and remotely control a media unit that is adapted to provide media content to a media device (e.g., a television). The media unit receives an identifier of the media device, and identifies wireless protocol codes for remotely operating the media device. The media unit wirelessly transmits the identified wireless protocol codes to the remote control, which are utilized to program the remote control to remotely operate the media device in addition to the media unit.

### RELATED APPLICATION

This application is related to U.S. patent application Ser. No. 11/502,051, entitled “MEDIA SYSTEM AND METHOD FOR PURCHASING, DOWNLOADING AND PLAYING MEDIA CONTENT”, which is hereby incorporated by reference.

This application is also related to U.S. patent application Ser. No. 11/760,744, entitled “SYSTEMS AND METHODS FOR SEARCHING AND FOR DISPLAYING MEDIA CONTENT”, U.S. patent application Ser. No. 11/760,745, entitled “SYSTEMS AND METHODS FOR SEARCHING AND FOR DISPLAYING MEDIA CONTENT”, and U.S. patent application Ser. No. 11/760,747, entitled “SYSTEMS AND METHODS FOR SEARCHING AND FOR DISPLAYING MEDIA CONTENT”, which are hereby incorporated by reference.

### BACKGROUND OF THE INVENTION

1. Field of the Invention

The invention relates to media systems, and in particular, to systems and methods for programming a remote control with wireless protocol codes utilized for controlling a media device.

2. Background

Many users have a variety of different types of media devices (e.g., televisions, DVD players, stereos, set top boxes, etc.) for experiencing different types of media content. Each associated media device typically has a remote control for wirelessly operating the media device. Functions of the media device that a user can remotely operate using the remote control include powering on/off the media device, adjusting the volume, adjusting the television channel presently displayed, etc. Each function of the media device typically corresponds to a particular infrared (IR) code received from a remote control. For example, the IR code corresponding to adjusting the volume will be different than the IR code corresponding to adjusting the channel. Thus, media devices are typically programmed to respond to a specific set of IR codes from a remote control.

It is inconvenient for users to switch between multiple remote controls at once to operate different media devices. In response to this inconvenience, programmable universal remotes have been developed that can be programmed to operate one or more media devices simultaneously. One common type of universal remote is designed to specifically operate a particular media device, such as a media server, set-top box, or satellite receiver, but can also be programmed to remotely operate other media devices, including a television, digital video disk (DVD) player, etc.

Typically, these programmable remotes have a read only memory (ROM) storing the IR codes for the most popular and common media devices. These IR codes are programmed into the remote control during manufacture, and are not subsequently modifiable by a user. Each set of IR codes is often associated with a numerical identifier. A user programs the remote control to communicate with a media device, such as a television, by entering a three digit code identifying the television into the remote control using the numeric keypad of the remote control. The remote control stores the three digit code for the television, and subsequently utilizes stored IR codes associated with the three digit code to remotely operate the television. The user may be able to program the remote control to remotely operate additional media devices, such as a DVD player, utilizing a similar process using a three digit code corresponding to the DVD player. Responsive to the programming process, the remote control maps specific keys to specific functions of the media devices.

One problem with universal remote controls is that the set of IR codes available in the remote control becomes fixed at manufacture. Thus, a subsequently developed media device (e.g., a television) may not be compatible with the remote control if the set of IR codes for the television was not stored on the remote control at the time of manufacture. This is especially problematic if the universal remote is one that is pre-configured to remotely operate a media unit (e.g., a media server, set top box, satellite receiver, etc.) because the user will be unable to program the remote control to operate the television. Therefore, the user will be unable utilize the same remote control to remotely operate both the media unit and the television. The user then needs to acquire a new remote control for the media unit that is compatible with the television in order to utilize the advantage of using a single remote control to operate both media devices. This is not only an inconvenience for the user, but a new remote control that is compatible with both devices may not be immediately available, and thus, the user will not be able to utilize a single remote control for both devices.

### SUMMARY

The invention solves the above and other related problems with improved systems and methods for programming a remote control to remotely operate a media device. The remote control is configured to communicate with and remotely control a media unit that is adapted to provide media content to a media device (e.g., a television). The media unit receives an identifier of the media device, and identifies wireless protocol codes for remotely operating the media device. The media unit wirelessly transmits the identified wireless protocol codes to the remote control, which are utilized to program the remote control to remotely operate the media device. Thus, the remote control can be dynamically programmed by the media unit to remotely operate the media device. Advantageously, a pre-configured remote control for a media unit can be subsequently programmed to remotely operate other devices without the wireless protocol codes for the media device being initially stored in the remote control at the time of manufacture.

An embodiment of the invention comprises a remote control for a media device of which the remote control is not programmed to control. The remote control comprises a storage medium, a processing system adapted to remotely control a media unit to provide media content to the media device, and a user interface adapted to receive an identifier for the media device from a user. The processing system is further adapted to transmit the identifier to the media unit, receive from the media unit wireless protocol codes for remotely controlling the media device and store the received wireless protocol codes on the storage medium. The processing system is further adapted to remotely control the media device utilizing the received wireless protocol codes.

Another embodiment of the invention comprises a media unit including a processing system adapted to receive a command from a remote control to provide media content to a media device for presentation to a user, receive an identifier for the media device and identify wireless protocol codes utilized by the remote control to remotely operate the media device based on the identifier. The media unit further comprises a wireless interface system adapted to transmit the wireless protocol codes to the remote control. The wireless protocol codes received by the remote control may then be utilized to program the remote control to remotely operate the media device.

The invention may include other exemplary embodiments described below.

### DESCRIPTION OF THE DRAWINGS

The same reference number represents the same element or same type of element on all drawings.

FIG. 1 illustrates a media system in an exemplary embodiment of the invention.

FIG. 2 illustrates exemplary details of the remote control of FIG. 1 in an exemplary embodiment of the invention.

FIG. 3 illustrates exemplary details of the media unit of FIG. 1 in an exemplary embodiment of the invention.

FIG. 4 illustrates a method for programming a remote control for remotely operating a media device in an exemplary embodiment of the invention.

FIG. 5 illustrates another method for programming a remote control for remotely operating a media device in an exemplary embodiment of the invention.

FIG. 6 illustrates a media system for displaying media content generated based on a television broadcast signal in an exemplary embodiment of the invention.

FIG. 7 illustrates another media system for displaying media content on a display device in an exemplary embodiment of the invention.

FIG. 8 illustrates a media system for displaying media content on the television of FIG. 6 in an exemplary embodiment of the invention.

FIG. 9 illustrates another method for programming a remote control for remotely operating a media device in another exemplary embodiment of the invention.

FIG. 10 illustrates a media system for programming a remote control in an exemplary embodiment of the invention.

FIG. 11 illustrates another method for programming a remote control for remotely operating a media device in an exemplary embodiment of the invention.

FIG. 12 illustrates another method for programming a remote control for remotely operating a media device in an exemplary embodiment of the invention.

### DETAILED DESCRIPTION OF THE INVENTION

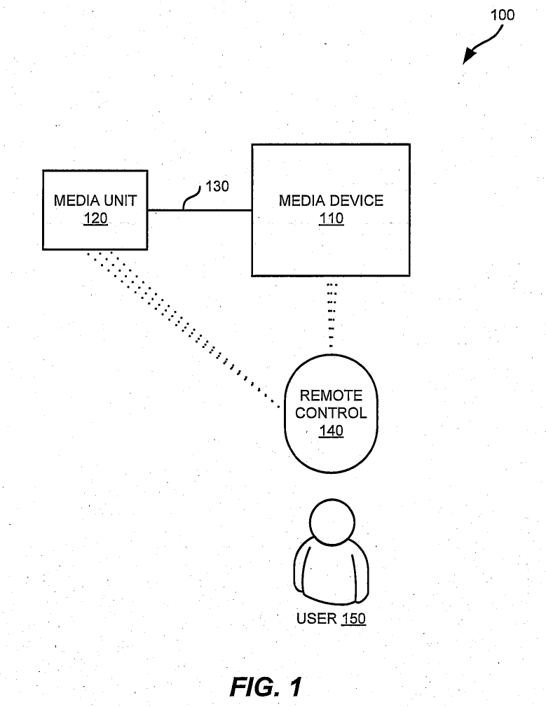

FIGS. 1-12 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a media system 100 in an exemplary embodiment of the invention. Media system 100 includes a media device 110 for playing and/or displaying media content, and other information, such as search menus, preferences menus, downloading and purchasing menus, etc. Media device 110 may be a display device (e.g., a television), an audio device (e.g., a stereo system), or any other type of suitable system adapted to provide media content to a user 150. Media device 110 is adapted to display and/or play different types of media content, for example audio content and music, pictures, television broadcasts, digitally-formatted videos, etc. Media content may be locally-stored within media unit 120, or downloaded or retrieved from peripheral devices, the internet, remote content sources, etc. Media content may be stored as one or more media files, such as MPEG files, GIFs, JPEGs, DVD videos, etc. Media device 110 will be herein described as a television adapted to display media content to a user. However, it will be appreciated that other types of media devices which do not provide display of media content to user 150 may be utilized in accordance with the invention.

Media system 100 further includes a media unit 120, which is adapted to provide media content to media device 110. Media unit 120 may be adapted to provide audio and/or video media content to media device 110. Exemplary embodiments of media unit 120 include media servers, set top boxes, satellite receivers, etc. The provided media content may comprise for example a video stream generated from a television broadcast signal, a digital video, etc.

Media unit 120 is connected to media device 110 through connection 130. Connection 130 may be any type of wired or wireless connection between media unit 120 and media device 110. Exemplary embodiments of connection 130 include coaxial cable, video connections, RCA video connections, WiFi, Bluetooth, Ethernet, etc. Media unit 120 may be connected to multiple media devices 110 through connection 130. For example, media unit 120 may connect to media device 110 using an existing building cable infrastructure (not shown in FIG. 1), which does not require the use of additional hardware or cabling.

Media system 100 further comprises a remote control 140 adapted to remotely control media unit 120 to provide media content to media device 110. User 150 may use remote control 140 to interact with menus displayed on media device 110 by media unit 120. Remote control 140 may include buttons which may be used for manipulating the menus. The menus may allow user 150 to search for media content for display on media device 110, as well as purchase and/or download media content from remote content sources, peripheral devices, etc.

Remote control 140 may be a universal type remote control which is programmable to remotely operate a plurality of other devices besides media unit 120, such as media device 110. However, remote control 140 is not initially programmed to remotely control media device 110. When remote control 140 is programmed with wireless protocol codes corresponding to media device 110, remote control 140 may be utilized to remotely operate media device 110. Media system 100 may comprise other devices, elements or components not illustrated for the sake of brevity.

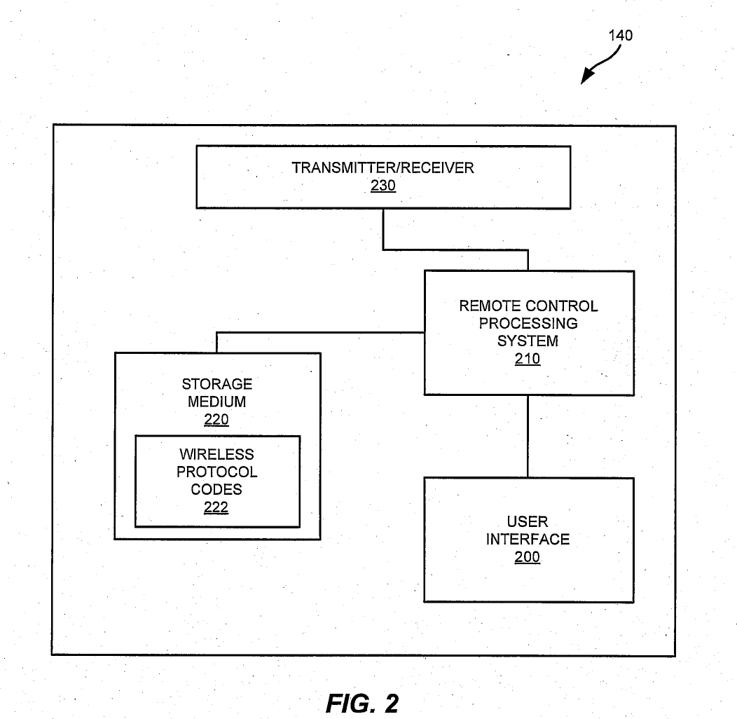

FIG. 2 illustrates exemplary details of remote control 140 of FIG. 1 in an exemplary embodiment of the invention. Remote control 140 comprises a user interface 200 adapted to receive input from user 150. For example, user interface 200 may comprise a keypad of remote control 140. User interface 200 may also be adapted to provide information to user 150 by providing audio and visual indicators. For example, user interface 200 may comprise a liquid crystal display (LCD) or light emitting diode (LED) for displaying information to user 150. User interface 200 may comprise a speaker for providing audio indicators to user 150.

Remote control 140 further comprises a remote control processing system 210 adapted to receive input from user interface 200 and translate the input into wireless protocol codes for remotely operating media unit 120 and/or media device 110. Remote control processing system 210 refers to a single processing device or a group of inter-operational processing devices. The operation of remote control processing system 210 may be controlled by instructions executable by remote control processing system 210. Some examples of instructions are software, program code, and firmware.

Remote control 140 further comprises a storage medium 220 adapted to store wireless protocol codes 222 for remotely operating media device 110. In one embodiment, wireless protocol codes 222 may comprise IR codes. During programming of remote control 140, remote control processing system 210 receives wireless protocol codes 222 from media unit 120, and stores wireless protocol codes 222 on storage medium 220. If remote control 140 is programmed to remotely operate multiple media devices 110, then storage medium 220 may store a plurality of sets of wireless protocol codes 222, each set of wireless protocol codes corresponding with a media device 110.

Remote control 140 further comprises a transmitter/receiver 230 adapted to wirelessly communicate with media unit 120 and/or media device 110. Transmitter/receiver 230 is adapted to transmit commands to remotely operate media unit 120, and receive information and/or commands from media unit 120. For example, transmitter/receiver 230 may receive wireless protocol codes 222 from media unit 120. Transmitter/receiver 230 may be adapted to communicate with media unit 120 over a radio frequency (RF) communication link, an IR communication link or other type of wireless communication link.

Transmitter/receiver 230 is further adapted to transmit commands to remotely operate media device 110. For example, transmitter/receiver 230 may transmit wireless protocol codes 222 to media device 110 for remotely operating media device 110. Transmitter/receiver 230 may be adapted to communicate with media device 110 over an RF communication link, an IR communication link or other type of wireless communication link.

Further, transmitter/receiver 230 may be adapted to communicate with media device 110 and media unit 120 over different types of wireless communication links. For example, transmitter/receiver 230 may be adapted to communicate with media unit 120 over an RF communication link. Thus, a direct line of sight is not necessary between media unit 120 and transmitter/receiver 230. On the other hand, most media devices 110 communicate with remote controls over IR communication links. Thus, transmitter/receiver 230 may be adapted to communicate with media device 110 over an IR communication link, with media device 110 in a direct line of sight with remote control 140. Remote control 140 may comprise other devices, elements or components not illustrated for the sake of brevity.

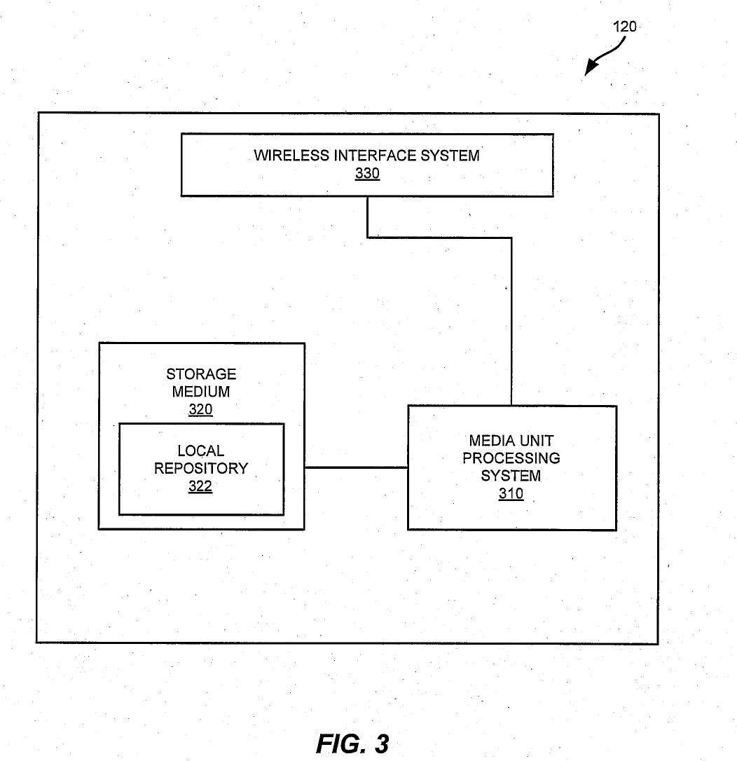

FIG. 3 illustrates exemplary details of media unit 120 of FIG. 1 in an exemplary embodiment of the invention. Media unit 120 comprises a media unit processing system 310 adapted to generate a media content stream provided to media device 110 (see FIG. 1) over connection 130. Media unit processing system 310 may generate and provide media content to media device 110 responsive to commands received from remote control 140. The media content stream may be generated from a television signal, stored media content (e.g., digital videos), remotely accessed media content, etc. Media unit processing system 310 may modulate media content over connection 130 in a format compatible with media device 110. Further, media unit processing system 310 may be adapted to provide media content to a plurality of media devices 110 simultaneously.

Media unit 120 may optionally comprise a storage medium 320 storing a local repository 322 of wireless protocol codes. Local repository 322 may be pre-configured on media unit 120 at the time of manufacture with known wireless protocol codes. Local repository 322 may be further updateable to store wireless protocol codes which were not stored in local repository 322 at the time of manufacture of media unit 120. Updates may be done periodically by media unit processing system 310 to ensure that local repository 322 is up to date. Alternatively, updates may be done at the request of user 150 or responsive to a request to program remote control 140.

Media unit 120 further comprises a wireless interface system 330. Wireless interface system 330 is adapted to receive commands from remote control 140 for remotely operating media unit 120, and provides the commands to media unit processing system 310. Wireless interface system 330 may communicate with remote control 140 utilizing any type of wireless communication link, such as an RF communication link or an IR communication link. Further, wireless interface system 330 may be adapted to communicate with a plurality of remote controls 140 simultaneously. For example, media system 100 may comprise a plurality of media devices 110 and a plurality of remote controls 140, and each remote control may be programmed to remotely control media unit 120 and one of the media devices 110 associated with remote control 140. Thus, each remote control 140 may remotely operate media unit 120 to provide media content to a media device 110 associated with remote control 140. Media unit 120 may comprise other devices, elements or components not illustrated for the sake of brevity.

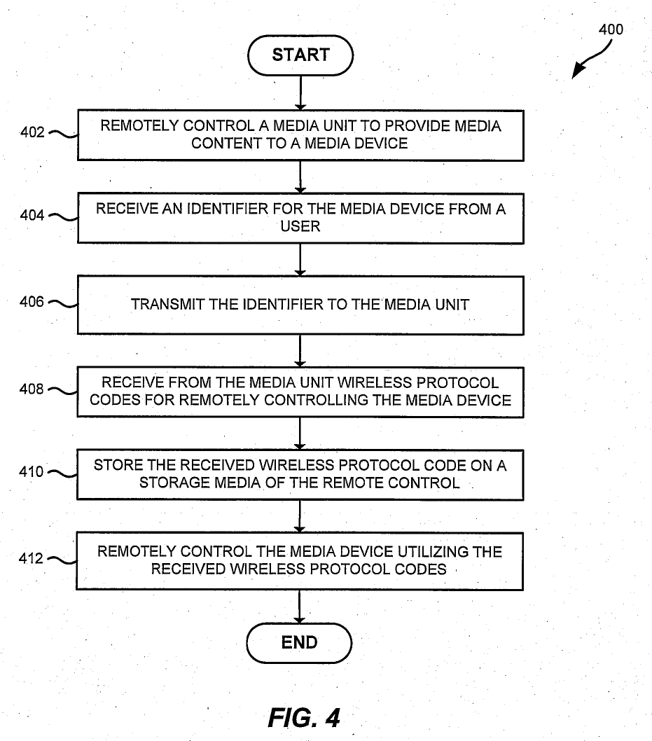

FIG. 4 illustrates a method 400 for programming a remote control for remotely operating a media device in an exemplary embodiment of the invention. The steps of method 400 will be described in reference to media system 100 illustrated in FIGS. 1-3. The steps of method 400 are not all-inclusive, and may include other steps not shown for the sake of brevity.

In step 402, remote control processing system 210 (see FIG. 2) of remote control 140 remotely controls media unit 120 (see FIG. 1) to provide media content to media device 110. Step 402 may be performed responsive to input from user 150. For example, user 150 may provide input instructing media unit 120 to provide media content in the form of a digital video to media device 110. Transmitter/receiver 230 provides the input to wireless interface system 330, and media unit processing system 310 of media unit 120 utilizes the input to provide media content to media device 110. At this point, remote control 140 is not programmed to remotely operate media device 110.

In step 404, user interface 200 (see FIG. 2) of remote control 140 receives an identifier for media device 110 from user 150. User 150 may provide the identifier via a keypad of user interface 200. The identifier may be in the form of a numerical code corresponding to the set of wireless protocol codes utilized to operate media device 110, a description of media device (e.g., manufacturer name, model name or number, etc.), a serial number of the media device, etc.

In step 406, remote control processing system 210 transmits the identifier to media unit 120 utilizing transmitter/receiver 230. In response, media unit 120 identifies wireless protocol codes corresponding to media device 110 based on the identifier, and transmits the identified wireless protocol codes to remote control 140. In step 408, remote control processing system 210 of remote control 140 receives the wireless protocol codes from media unit 120 for remotely controlling media device 110. Remote control processing system 210 may receive the wireless protocol codes via transmitter/receiver 230 of remote control 140.

In step 410, remote control processing system 210 stores wireless protocol codes 222 on storage medium 220. On storage medium 220, wireless protocol codes 222 may be mapped to specific buttons of user interface 200 of remote control 140. Thus, when user 150 presses one of the buttons of user interface 200, remote control processing system 210 may identify the wireless protocol code corresponding to the pressed button utilized for remotely controlling media device 110. In step 412, remote control processing system 210 remotely controls media device 110 utilizing wireless protocol codes 222.

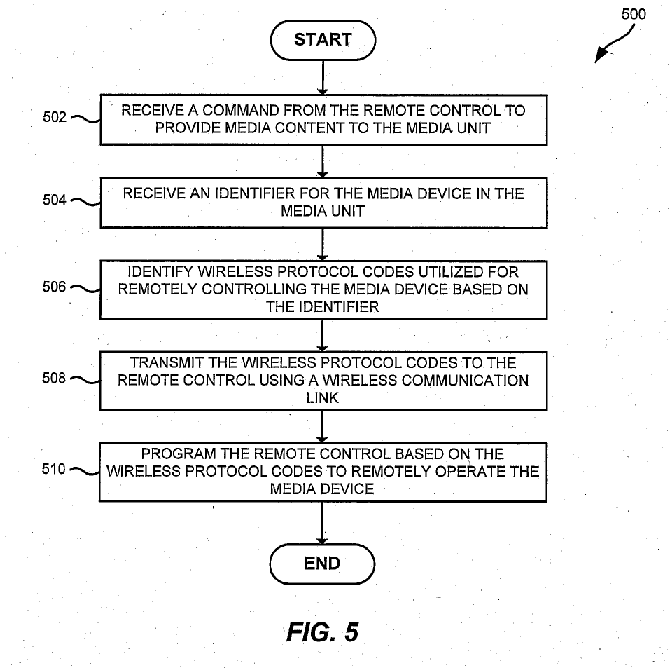

FIG. 5 illustrates another method 500 for programming a remote control for remotely operating a media device in an exemplary embodiment of the invention. The steps of method 500 will be described in reference to media system 100 illustrated in FIGS. 1-3. The steps of method 500 are not all-inclusive, and may include other steps not shown for the sake of brevity.

In step 502, media unit processing system 310 of media unit 120 receives a command from a remote control to provide media content to media device 110 for presentation to user 150. Remote control 140 may transmit the command to wireless interface system 330, and wireless interface system 330 may provide the command to media unit processing system 310. Remote control 140 may provide the command to media unit 120 as described above in step 402 of FIG. 4.

In step 504, media unit processing system 310 receives an identifier for media device 110. Media unit processing system 310 may receive the identifier from remote control 140 or another device in signal communication with remote control 140. For example, media unit processing system 310 may receive the identifier from a computer (not shown) coupled to media unit 120, a keyboard, other input device coupled to media unit 120, a mobile telephone, personal digital assistant (PDA), etc. The identifier may be in the form of a numerical code corresponding to the set of wireless protocol codes utilized to operate media device 110, a description of media device 110 (e.g., manufacturer name, model name or number, etc.), a serial number of media device 110, etc.

In step 506, media unit processing system 310 identifies wireless protocol codes utilized by remote control 140 to remotely operate media device 110. Media unit processing system 310 may identify the wireless protocol codes by searching local repository 322, by querying an external server (not shown in FIG. 1), etc.

In step 508, wireless interface system 330 transmits the wireless protocol codes to remote control 140. In step 510, remote control processing system 210 programs remote control 140 based on the wireless protocol codes to remotely operate media device 110. Remote control processing system 210 may be programmed to remotely control media device 110 as described in steps 408 and 410 of FIG. 4. Remote control processing system 210 may then remotely control media device 110 utilizing wireless protocol codes 222.

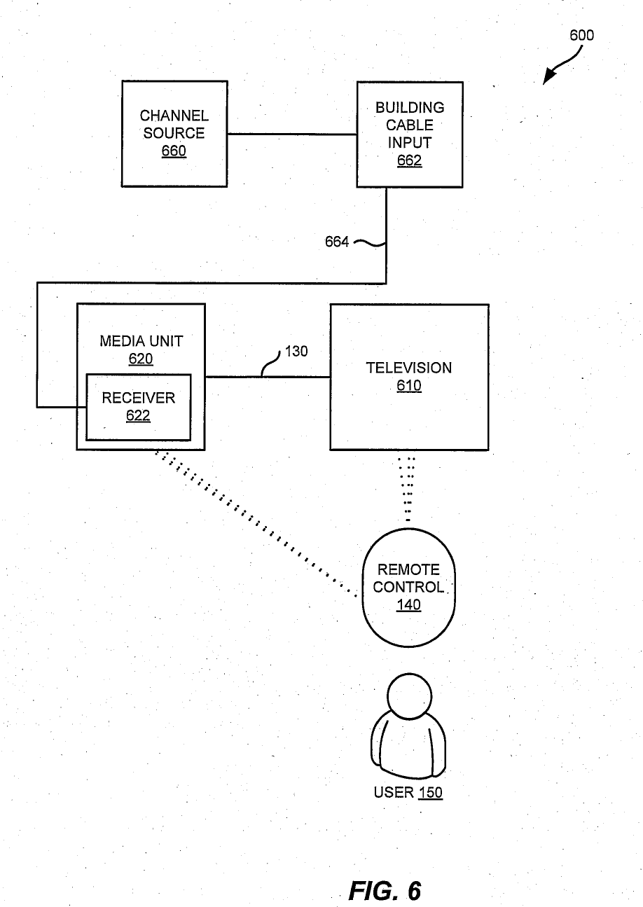

Media unit 120 may be embodied as a device which receives a television broadcast signal and provides media content to media device 110 based on the television broadcast signal. FIG. 6 illustrates a media system 600 for displaying media content generated based on a television broadcast signal in an exemplary embodiment of the invention. Media system 600 includes a television 610 for displaying media content, and other information, such as search menus, preferences menus, downloading and purchasing menus, etc.

Media system 600 further comprises a media unit 620 adapted to provide media content to television 610 over connection 130. Media unit 620 may comprise a set-top box, satellite receiver or other type of television signal receiver. Media unit 620 may include similar components as media unit 120 of FIG. 1, and additionally comprises a receiver 622. In one embodiment, receiver 622 is adapted to receive a television broadcast signal over building cable infrastructure 664, and is further adapted to decode the television broadcast signal and provide media content to television 610 based on the decoded television broadcast signal. Building cable infrastructure 664 may be any cabling or network system adapted to connect a television 610 to a television signal source. For example, building cable infrastructure 664 may be a coaxial cable infrastructure present in many buildings which allows a television to connect to a cable system, satellite dish, antenna, etc. Building cable infrastructure 664 may connect to building cable input 662, which connects building cable infrastructure 664 to a channel source 660. Television 610 may alternatively connect to channel source 660 through a wireless network (not shown).

Channel source 660 provides television 610 with one or more modulated service channels. Service channels are specific frequency bands corresponding with FCC-allocated channels for broadcast or cable television. While the present application refers to broadcasts and cable television systems, those of ordinary skill in the art will recognize that the systems, devices and methods described herein may also be applied to display devices and media systems which receive television signals and media content through satellite dishes, antennas and other types of receivers. Thus, signals from broadcasts, cable and other types of channel services are herein referred to as service channels. Further, a channel source refers to any type of source of service channels.

Television 610 receives one or more signals corresponding with one or more service channels, and is adapted to selectively tune and demodulate the frequency band corresponding with a service channel to reproduce the audio and/or video content contained within the service channel signal. Television 610 may also receive a signal carrying media content from a device or network, such as using an Ethernet connection or video cables. Channel source 660 may use only a portion of the allocated channels, while leaving some channels unused. Therefore, service channels include modulated service channels which are used by channel source 660, and may un-modulated service channels, which are not used by channel source 660. The modulated service channels are modulated with media content, such as audio and visual media from television stations, radio stations, cable providers, etc.

Though media unit 620 is illustrated as connected to television 610 through connection 130, it will be appreciated that media unit 620 and television 610 may alternatively be connected through building cable infrastructure 664. Thus, media unit 620 may connect to television 610 using the existing building cable infrastructure 664, and does not require the use of additional hardware or cabling.

To display media content on television 610, media unit 620 may modulate media content over an allocated channel of channel source 660. Preferably, media unit 620 utilizes an un-modulated service channel of channel source 660. For example, if channel 73 corresponds to an unused service channel of channel source 660, then media unit 620 may modulate media content over channel 73, and television 610 may be tuned to channel 73 in order for television 610 to receive and to display the media content. User 150 may manually tune television 610 to the un-modulated channel, or media unit 620 and/or remote control 140 may automatically perform the tuning process responsive to a user selecting to view media content from media unit 620. For example, assume that remote control 140 has a button for viewing media content on media unit 120. Media unit 620 and/or remote control 140 may automatically identify an un-modulated channel and tune television 610 to the un-modulated channel. Additionally, two or more televisions 610 may be tuned to the same channel to display the same media content.

If channel source 660 includes no un-modulated service channels (i.e., all of the service channels are presently used), then media unit 620 may utilize a modulated service channel of channel source 660 for displaying media content. In this configuration, media unit 620 may be connected to building cable input 662 to receive signals corresponding with the service channels of channel source 660. Television 610 may then couple to media unit 620 to receive signals corresponding with the service channels of channel source 660. Media unit 620 may selectively filter one or more service channels of channel source 660, and use a filtered service channel to display m e d i a content on television 610. The filtering may be performed by a supercombiner (not shown) coupled to or built in to building cable input 662. A supercombiner is used herein refers to a device employed at the root splitter location of a building's cable infrastructure allowing intended upstream (i.e. directed outside of the building) communication while preventing unintended upstream signaling (such as from internally-distributed content) and enabling the distribution of content sourced from any leg of the local infrastructure to be accomplished in a manner which results in the quality of distribution to be largely insensitive to the leg from which it is sourced. A supercombiner may additionally perform filtering of incoming spectrum, execute characterization and/or calibration of building infrastructure in conjunction with a media unit, and/or other functions.

Filtering may be performed by the supercombiner responsive to commands by media unit 620. For example, user 150 may select a modulated service channel of channel source 660 for use by media unit 620 (e.g., channel 73), and media unit 620 and/or the supercombiner of building cable input 662 may filter the frequency corresponding with the selected service channel from the signal transmitted by channel source 660 before the signal reaches television 610 (i.e., media unit 620 may remove the selected service channel from the signal).

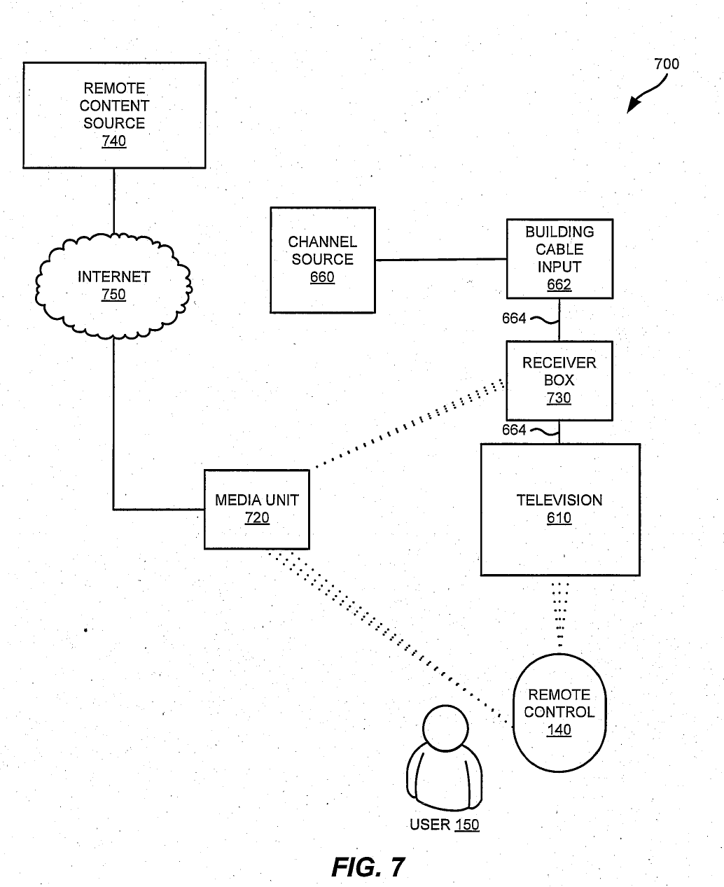

FIG. 7 illustrates another media system 700 for displaying media content on a media device 110. Media unit 720 may be similar to media unit 120 of FIG. 1 or media unit 620 of FIG. 6. Media unit 720 communicates with a receiver box 730 attached to television 610 through a wireless connection. Receiver box 730 is attached to television 610 using standard audio and/or video connectors, such as coax cable, an RCA connector, an HDMI connector, etc. For example, media unit 610 and receiver box 730 may communicate using a Multimedia over Cable Alliance “MOCA” connection.

Receiver box 730 includes a transmitter/receiver to communicate with media unit 720 through a wireless connection. Alternatively, media unit 720 may be connected to receiver box 730 through a wired connection, such as Ethernet, coax or video cables. Receiver box 730 may be connected to a remote content source 740 through internet 750 to receive media content. In one embodiment, media unit 720 may be connected to a computer (not shown in FIG. 1). Thus, media unit 720 may generate a content stream from media content received from remote content source 740 or the computer. Media unit 720 may transmit menus, media content and other information to receiver box 730 over the wireless connection. Receiver box 730 may then produce output for display on television 610 based on the data received from media unit 620.

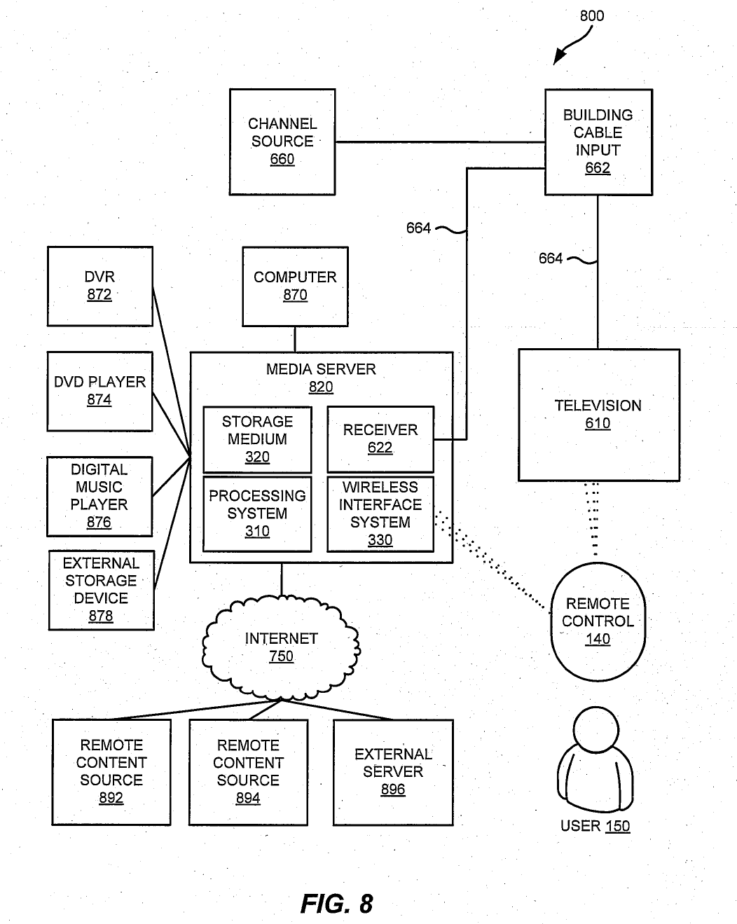

FIG. 8 illustrates a media system 800 for displaying media content on television 610 of FIG. 6 in an exemplary embodiment of the invention. Media server 820 may be connected to building cable infrastructure 664 through building cable input 662. Media server 820 may be similar to media unit 120 of FIG. 1, and includes storage medium 320 for storing media content for present or future viewing or playback. Media server 820 may be connected to a plurality of peripheral devices, such as a computer 870, a digital video recorder (DVR) 872, a digital video disk (DVD) player 874 or other type of optical disk player, a digital music player 876, or an external storage device 878, such as a USB flash drive storing pictures, music, videos, etc. Media server 820 may retrieve media content from any of the peripheral devices, and modulate the media content onto an un-modulated service channel for display on television 610.

Media server 820 may also connect to one or more remote content sources 892-894 through internet 750 or other type of network used for distributing media content for display on television 610. Media server 820 may download media content from remote content sources 892-894, and may persistently store the media content on storage medium 320 for later use. Alternatively, media server 820 may buffer media content from remote content sources 892-894 for display on television 610 during the present viewing session of user 150, but media server 820 may not persistently store the buffered media content for later use.

Remote content sources 892-894 may be any type of servers, services or devices for providing media content to media server 820. For example, remote content sources 892-894 may be vendors of media content, and user 150 may purchase media content from one or more remote content sources 892-894 for display on television 610. One of remote content sources 892-894 may also comprise a media search engine which aggregates descriptions of media content from a plurality of other remote content sources 892-894, and then provides the descriptions of the media content to media server 820 responsive to a search request from user 150. Thus, user 150 may search media content from a variety of sources, and then select media content from one or more of the sources for viewing on television 610. Remote content sources 892-894 may also be adapted to provide downloads of media content, buffered media content, etc.

Media system 800 also includes an external server 896, which is adapted to provide wireless protocol codes utilized by remote control 140 to media server 820. Media server 820 and external server 896 are coupled through internet 750. Media server 820 may query external server 896 for wireless protocol codes responsive to a request from user 150. Alternatively, media server 820 may periodically query external server 896 to download wireless protocol codes for updating local repository 322 (see FIG. 3), or external server 896 may periodically push updated wireless protocol codes to media server 820 to update local repository 322 (see FIG. 3).

Remote control 140 is configured to remotely control media server 820 to provide display and/or playback of media content on television 610. Remote control 140 may be additionally programmed to remotely operate any of television 610, computer 870, DVR 872, DVD player 874, digital music player 876 and/or external storage device 878. Remote control 140 may be programmed to remotely control each of these devices as described in methods 400 and 500 of FIGS. 4-5. Thus, user 150 would provide an identifier for each of television 610, computer 870, DVR 872, DVD player 874, digital music player 876 and/or external storage device 878, and media server 820 would identify the wireless protocol codes utilized by remote control 140 to remotely operate each device.

In another exemplary embodiment, media server 820 may be adapted to receive user input from remote control 140 to remotely operate one of the external media devices, and may be adapted to translate the user input into the corresponding wireless protocol codes for the selected media device. For example, user 150 may desire to play a movie from DVD player 874 coupled to media server 820. User 150 may press a play button on remote control 140. Wireless interface system 330 receives the user input from remote control 140, and processing system 310 translates the user input into a wireless protocol code for DVD player 820 (e.g., the wireless protocol code for the play function of DVD player 874). Wireless interface system 330 then transmits the wireless protocol code to DVD player 874. DVD player 874 receives the wireless protocol code, and then initiates play of a movie stored on a disk in DVD player 874. Advantageously, the storage and translation of wireless protocol codes may be performed on media server 820 rather than remote control 140. Thus, remote control 140 can be designed to interface with media server 820, and media server 820 can perform the actual storage and translation of wireless protocol codes utilized to remotely operate various media devices. While the described exemplary embodiment refers to a media server, it will be appreciated that the teachings may be applied to other types of media units as described above.

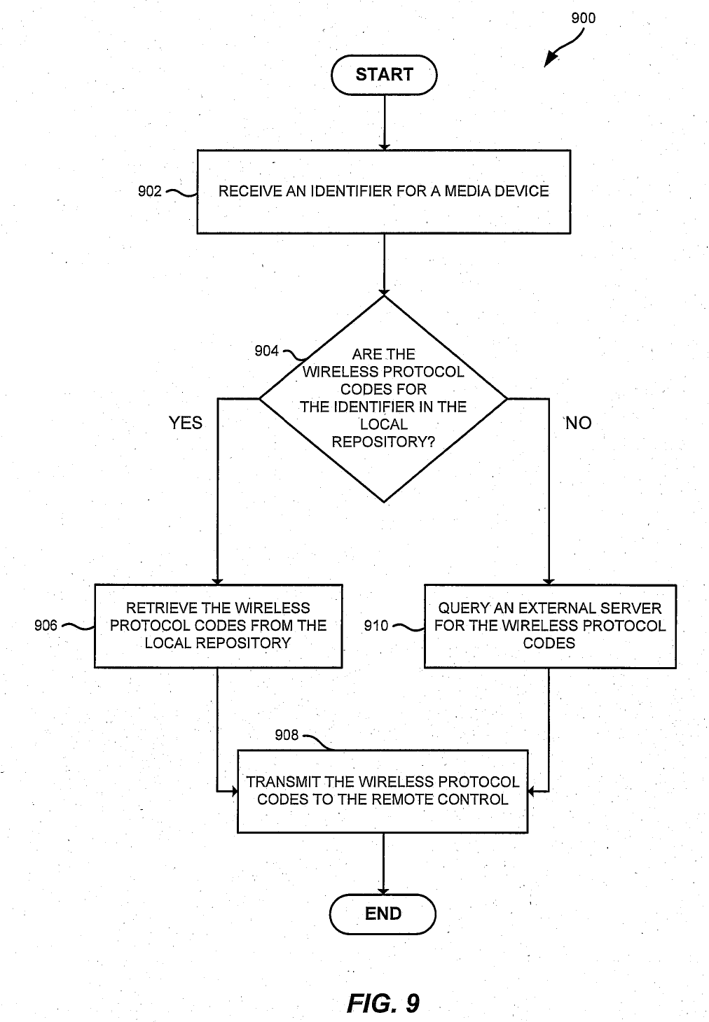

FIG. 9 illustrates a method 900 for programming a remote control for remotely operating a media device in another exemplary embodiment of the invention. The steps of method 900 will be described in reference to media system 800 illustrated in FIG. 8. The steps of method 900 are not all-inclusive, and may include other steps not shown for the sake of brevity.

In step 902, media server 820 receives an identifier from user 150 for one of television 610, computer 870, DVR 872, DVD player 874, digital music player 876 and/or external storage device 878. Media server 820 may receive the identifier from remote control 140 or computer 870.

In step 904, media unit processing system 310 determines whether wireless protocol codes corresponding to the identifier are stored in a local repository 322 (see FIG. 3) of storage medium 320. For example, the identifier may comprise a numerical code, and media unit processing system 310 may determine whether local repository 322 (see FIG. 3) stores wireless protocol codes corresponding to the numerical identifier. Alternatively, the identifier may comprise other information, such as a model number of the media device that remote control 140 will be programmed to remotely operate.

If the wireless protocol codes corresponding to the identifier are found in local repository 322 (see FIG. 3), then media unit processing system 310 retrieves the wireless protocol codes in step 906, and transmits the wireless protocol codes to remote control 140 in step 908. The wireless protocol codes are then utilized to program remote control 140 to remotely operate a media device (e.g., television 610, computer 870, DVR 872, DVD player 874, digital music player 876 and/or external storage device 878). Media server 820 may receive the identifier from remote control 140 or computer 870.

If the wireless protocol codes corresponding to the identifier are not found in local repository 322 (see FIG. 3), then media unit processing system 310 queries external server 896 in step 910 for wireless protocol codes corresponding to the identifier. In step 908, processing system transmits the wireless protocol codes to remote control 140, which are utilized to program remote control 140.

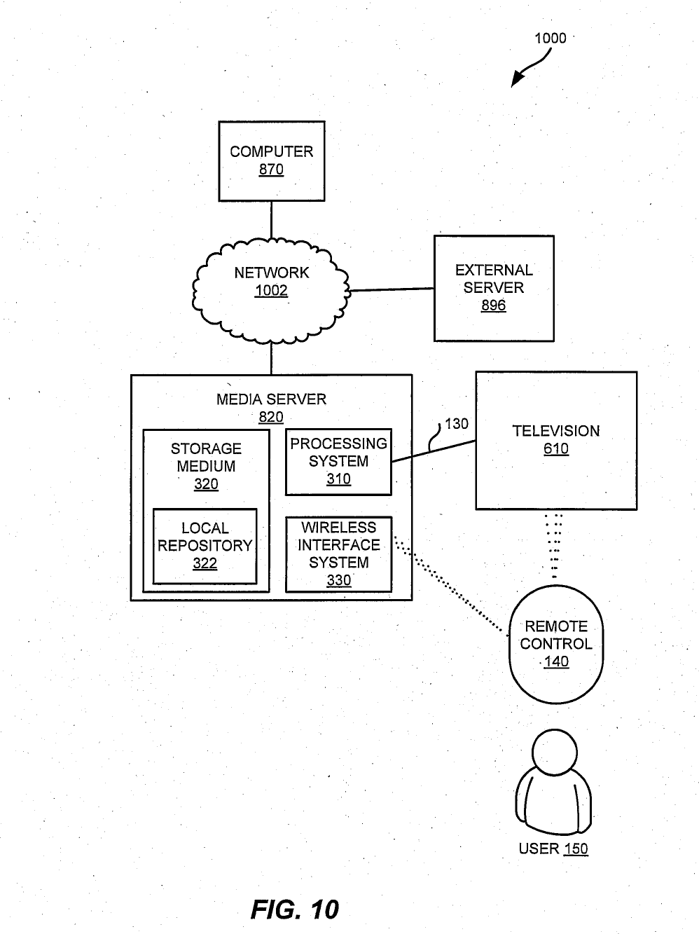

FIG. 10 illustrates a media system 1000 for programming a remote control in an exemplary embodiment of the invention. Media system 1000 includes a television 610 or other type of media device for presenting media content to user 150. Media system 1000 further comprises a media server 820, including a storage medium 320, a media unit processing system 310 and a wireless interface system 330. Media server 820 and television 610 are coupled through connection 130.

Media system 1000 further comprises a computer 870 coupled to media server 820 through internet 750. Media system 1000 further comprises an external server 896 coupled to computer 870 and/or media server 820 through network 1002. Network 1002 may be an internal network, such as a local area network, and/or an external network, such as the internet. Furthermore, the network connection between computer 870 and media server 820 need not be the same network connection between media server 820 and external server 896. Computer 870 may be adapted to identify wireless protocol codes utilized by remote control 140 to remotely operate television 610. Computer 870 may identify wireless protocol codes by querying external server 896 and/or media server 820. Alternatively, computer 870 may store a local repository of wireless protocol codes (not shown in FIG. 10) to identify wireless protocol codes corresponding to the identifier. Once computer 870 identifies the wireless protocol codes corresponding to the identifier (e.g., by receiving wireless protocol codes responsive to a query to external server 896), computer 870 transmits the wireless protocol codes to media server 820. Wireless interface system 330 of media unit then transmits the wireless protocol codes to remote control 140, which are utilized to program remote control 140 to remotely operate television 610.

Alternatively, media server 820 may be adapted to query external server 896 directly to identify wireless protocol codes utilized by remote control 140 to remotely operate television 610 responsive to receiving an identifier for television 610 from computer 870. Media server 820 would then receive wireless protocol codes corresponding to the identifier from external server 896, and then transmit the wireless protocol codes to media server 820, which are utilized to program remote control 140 to remotely operate television 610. Media system 1000 may comprise other devices, elements or components not illustrated for the sake of brevity.

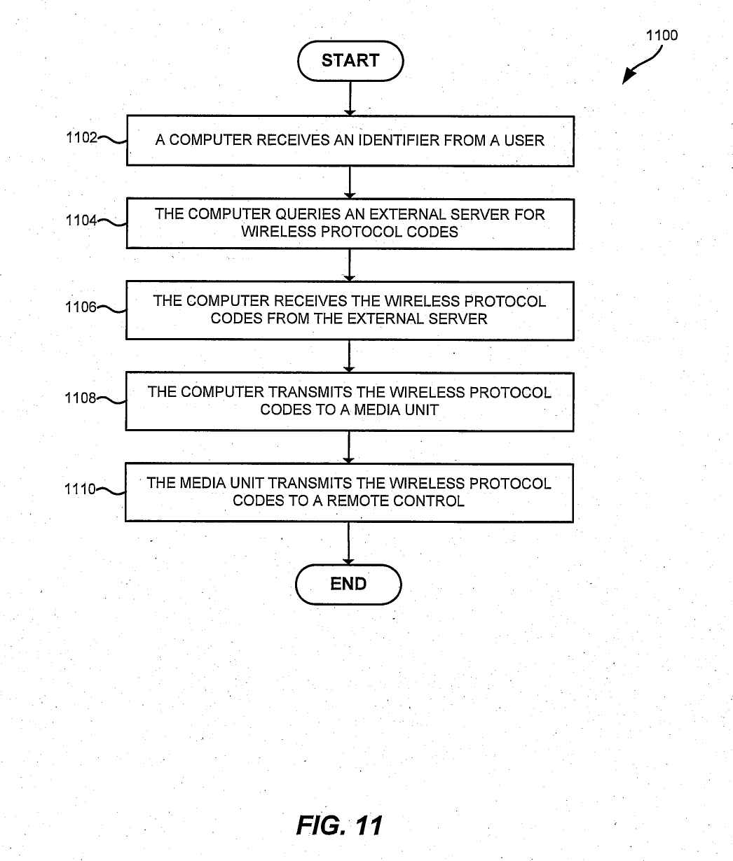

FIG. 11 illustrates another method 1100 for programming a remote control for remotely operating a media device in an exemplary embodiment of the invention. The steps of method 1100 will be described in reference to media system 1000 illustrated in FIG. 10. The steps of method 1100 are not all-inclusive, and may include other steps not shown for the sake of brevity.

In step 1102, computer 870 receives an identifier for television 610 from user 150. User 150 may provide the identifier to computer 870 through any type of input device, such as a keyboard, mouse, microphone, etc. Computer 870 may operate specialized software utilized for programming media server 820 and/or remote control 140. User 150 may provide the identifier through one or more menus displayed by computer 870.

In step 1104, computer 870 queries external server 896 for wireless protocol codes corresponding to the identifier. Responsive to the query, external server 896 identifies wireless protocol codes corresponding to the identifier, and transmits the identified wireless protocol codes to computer 870. In step 1106, computer 870 receives the wireless protocol codes from external server 896.

In step 1108, computer 870 transmits the wireless protocol codes to media server 820. In step 1110, wireless interface system 330 of media server 820 transmits the wireless protocol codes to remote control 140. The transmission process may be similar to step 508 of FIG. 5. The wireless protocol codes are then utilized to program remote control 140 to remotely operate television 610.

Advantageously, user 150 may utilize computer 870 to identify wireless protocol codes utilized by remote control 140 to remotely operate television 610. Computer 870 may then provide the identified wireless protocol codes to media server 820, which utilizes the wireless protocol codes to wirelessly program remote control 140 to remotely operate television 610.

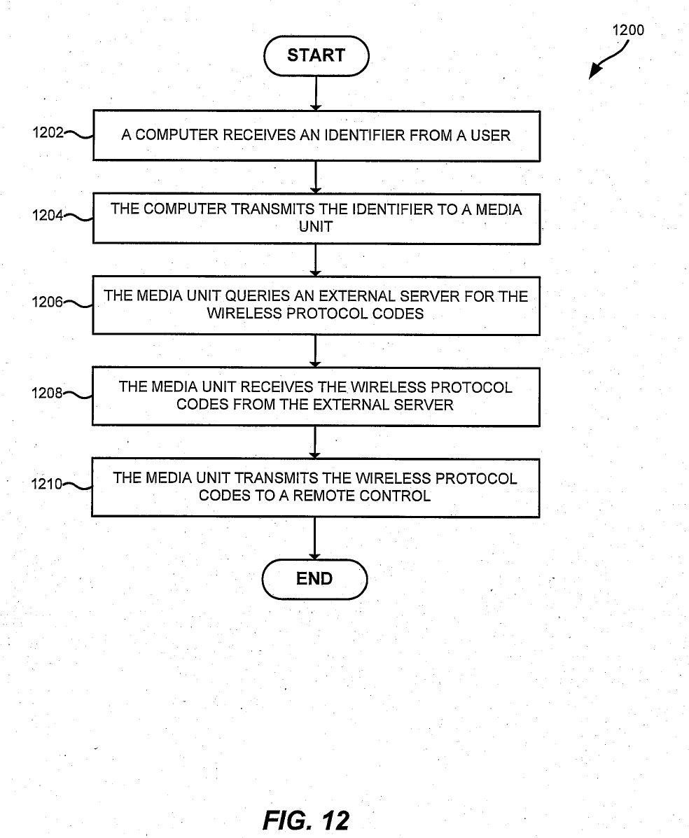

FIG. 12 illustrates another method 1200 for programming a remote control for remotely operating a media device in an exemplary embodiment of the invention. The steps of method 1200 will be described in reference to media system 1000 illustrated in FIG. 10. The steps of method 1200 are not all-inclusive, and may include other steps not shown for the sake of brevity.

In step 1202, computer 870 receives an identifier for television 610 from user 150. The input process may be similar to step 1102 of FIG. 11. In step 1204, computer 870 transmits the identifier to media server 820. In step 1206, media server 820 queries external server 896 for wireless protocol codes corresponding to the identifier. Responsive to the query, external server 896 identifies wireless protocol codes corresponding to the identifier, and transmits the identified wireless protocol codes to media server 820. In step 1208, media server 820 receives the wireless protocol codes from external server 896. In step 1210, wireless interface system 330 of media server 820 transmits the wireless protocol codes to remote control 140. The transmission process may be similar to step 508 of FIG. 5. The wireless protocol codes are then utilized to program remote control 140 to remotely operate television 610.

Advantageously, user 150 may utilize computer 870 to provide an identifier for television 610, and media server 820 may identify wireless protocol codes utilized by remote control 140 to remotely operate television 610 responsive to the receiving the identifier. Media server 820 may then utilize the wireless protocol codes to wirelessly program remote control 140 to remotely operate television 610. This process allows computer 870 to provide a simple interface for user 150 to program remote control 140. Media server 820 and computer 870 may then cooperatively operate to program remote control 140.

Although specific embodiments were described herein, the scope of the invention is not limited to those specific embodiments. The scope of the invention is defined by the following claims and any equivalents therein.

We claim:

1. A remote control for a media device of which the remote control is not programmed to control, the remote control comprising:
a storage medium;
a processing system adapted to remotely control a media unit to provide media content to the media device;
a user interface adapted to receive an identifier for the media device from a user,
the processing system further adapted to:
transmit the identifier to the media unit;
receive from the media unit wireless protocol codes for remotely controlling the media device;
store the received wireless protocol codes on the storage medium; and
remotely control the media device utilizing the received wireless protocol codes.

2. The remote control of claim 1, wherein the wireless protocol codes comprise infrared (IR) codes.

3. The remote control of claim 1, wherein the processing system is adapted to communicate with the media unit through a radio frequency (RF) communication link.

4. The remote control of claim 1, wherein the media device comprises a display device.

5. The remote control of claim 1, wherein the interface system comprises a keypad of the remote control.

6. A media unit comprising:
a processing system adapted to:
receive a command from a remote control to provide media content to a media device for presentation to a user;
receive an identifier for the media device; and
identify wireless protocol codes utilized by the remote control to remotely operate the media device based on the identifier; and
a wireless interface system adapted to transmit the wireless protocol codes to the remote control.

7. The media unit of claim 6 further comprising:
a receiver adapted to:
receive a television broadcast signal; and
decode the television broadcast signal,
wherein the processing system is further adapted to provide the media content to the media device based on the decoded television broadcast signal.

8. The media unit of claim 6, wherein the wireless protocol codes comprise infrared (IR) codes.

9. The media unit of claim 6, wherein the media device comprises a display device.

10. The media unit of claim 6, wherein the processing system is adapted to receive the identifier from the remote control.

11. The media unit of claim 6, wherein the wireless interface system is adapted to communicate with the remote control through a radio frequency (RF) communication link.

12. The media unit of claim 6, wherein the processing system is adapted to receive the identifier from a computer in signal communication with the media unit.

13. The media unit of claim 6, wherein the processing system is further adapted to:
query an external server to identify the wireless protocol codes for operating the media device.

14. The media unit of claim 6 further comprising:
a storage medium adapted to store a local repository of wireless protocol codes corresponding to a plurality of media devices, and
the processing system is further adapted to identify the wireless protocol codes for operating the media device from the local repository of wireless protocol codes based on the identifier.

15. The media unit of claim 14, wherein the processing system is further adapted to:
determine that the wireless protocol codes corresponding to the identifier are not found in the local repository of wireless protocol codes; and
query an external server to identify the wireless protocol codes for remotely operating the media device responsive to determining that the wireless protocol codes corresponding to the identifier are not found in the local repository of wireless protocol codes.

16. The media unit of claim 14, wherein the processing system is further adapted to query an external server to retrieve updated sets of wireless protocol codes for the local repository of wireless protocol codes.

17. The media unit of claim 14, wherein the processing system is further adapted to periodically receive from an external server updated sets of wireless protocol codes for the local repository of wireless protocol codes.

18. The media unit of claim 6, wherein the media unit comprises a media server.

19. The media unit of claim 6, wherein the media unit comprises a set top box.

20. The media unit of claim 6, wherein the media unit comprises a satellite receiver.

21. A method for programming a remote control for remotely operating a media device, the method comprising:
receiving a command in a media unit from the remote control to provide media content to the media device for presentation to a user;
receiving an identifier for the media device in the media unit;
identifying wireless protocol codes utilized for remotely controlling the media device based on the identifier; and
transmitting the wireless protocol codes to the remote control using a wireless communication link to allow programming of the remote control to remotely operate the media device.

22. The method of claim 21, further comprising:
programming the remote control based on the wireless protocol codes to remotely operate the media device.

23. The method of claim 21, wherein the wireless protocol codes comprise infrared (IR) codes.

24. The method of claim 21, wherein the media content provided to the media device is generated based on a decoded television broadcast signal.

25. The method of claim 21, wherein receiving the identifier for the media device further comprises:
receiving the identifier for the media device from the remote control.

26. The method of claim 21, wherein receiving the identifier for the media device from the remote control further comprises:
receiving the identifier from the remote control through a radio frequency (RF) communication link.

27. The method of claim 21, wherein receiving the identifier for the media device further comprises:
receiving the identifier for the media device from a computer.

28. The method of claim 21, wherein identifying the wireless protocol codes further comprises:
querying an external server to identify the wireless protocol codes for operating the media device.

29. The method of claim 21, wherein identifying the wireless protocol codes further comprises:
searching a local repository of wireless protocol codes to identify the wireless protocol codes for operating the media device.

30. The method of claim 29, further comprising:
querying an external server to retrieve updated sets of wireless protocol codes for the local repository of wireless protocol codes.

31. The method of claim 29, further comprising:
receiving periodically from an external server updated sets of wireless protocol codes for the local repository of wireless protocol codes.

32. The method of claim 29, wherein identifying the wireless protocol codes further comprises:
determining that the wireless protocol codes corresponding to the identifier are not found in the local repository of wireless protocol codes; and
querying an external server to identify the wireless protocol codes for operating the media device responsive to determining that the wireless protocol codes corresponding to the identifier are not found in the local repository of wireless protocol codes.

33. The method of claim 21, wherein the media unit comprises a media server.

34. The method of claim 21, wherein the media unit comprises a set top box.

35. The method of claim 21, wherein the media unit comprises a satellite receiver.

36. A method for programming a remote control for remotely operating a media device, the method comprising:
remotely controlling a media unit to provide media content to the media device;
receiving an identifier for the media device from a user;
transmitting the identifier to the media unit;
receiving from the media unit wireless protocol codes for remotely controlling the media device;
storing the received wireless protocol codes on a storage medium of the remote control; and
remotely controlling the media device utilizing the received wireless protocol codes.

37. The method of claim 36, wherein the wireless protocol codes comprise infrared (IR) codes.

38. The method of claim 36, wherein the remote control communicates with the media unit through a radio frequency (RF) communication link.

39. The method of claim 36, wherein the media device comprises a display device.

40. The method of claim 36, wherein receiving the identifier for the media device from the user further comprises:
receiving the identifier through a keypad of the remote control.

41. A media unit comprising:
a processing system adapted to:
receive user input from a remote control instructing a first media device coupled to the media unit to provide media content for presentation to a user on a second media device; and
translate the user input into a wireless protocol code for the first media device, and
a wireless interface system adapted to transmit the wireless protocol code to the first media device to remotely operate the first media device.

42. The media unit of claim 41, wherein the wireless protocol code comprises an infrared code.

43. The media unit of claim 41, wherein the processing system is adapted to communicate with the media unit through a radio frequency (RF) communication link.

44. A method for providing media content for presentation to a user, the method comprising:
receiving user input in a media unit from a remote control instructing a first media device coupled to the media unit to provide media content for presentation to a user on a second media device;
translating the user input into a wireless protocol code for the first media device; and
transmitting the wireless protocol code to the first media device.
